(19) United States
(12) Patent Application Publication
(10) Pub. No.: US 2007/0237527 A1
(43) Pub. Date: Oct. 11, 2007

(54) Optical debug mechanism

(76) Inventors: Sanjay Dabral, Palo Alto, CA (US); Mohiuddin Mazumder, San Jose, CA (US); Ken Drottar, Portland, OR (US); Hai-Feng Liu, Cupertino, CA (US)

Correspondence Address: CARRIE A. BOONE, P.C., 1110 NASA Parkway, SUITE 450, HOUSTON, TX, 77058, US

(21) Appl. No.: 11/394,697

(22) Filed: Mar. 31, 2006

(51) Int. Cl. H04B 10/04

(52) U.S. Cl. 398/183

(57) ABSTRACT

A method for performing analysis of electrical signals in a system is disclosed. The system includes at least two circuit elements between which an electrical signal is transmitted. The method converts the electrical signal to dual optical signals, one of which is converted back to an electrical signal for receipt by the intended circuit element. The second optical signal may be transmitted a great distance, relative to electrical signals, allowing for remote analysis of the signal. The loss in converting the electrical signal to an optical signal, then back to an electrical signal is low compared to other debug methods. The method may be performed with high-speed signals.

### TECHNICAL FIELD

This application relates to debugging of signals in electrical systems and, more particularly, to the analysis of high-speed signals transmitted in electrical systems.

### BACKGROUND

During validation and performance modeling of a system, electrical signals are often probed for system debug and trace capture. Traditionally, the signals are probed directly, such as by landing the probes on a bus or a link on a printed circuit board (PCB) of the system. For high-speed digital signals, however, direct probing may be inadequate. The probe itself may cause discontinuities in the signal or the signal speed may be difficult to capture by the test equipment.

Alternatives to direct probing include “copy and repeat” schemes, in which a debug chip is placed in the middle of a serial link between chips on the printed circuit board. The debug chip forwards the incoming signal to the recipient chip, and simultaneously sends a copy of the signal to a logic analyzer or other test equipment. The drawbacks to the “copy and repeat” method include system perturbations, such as latency, as well as an increase in power requirement, area, and cooling.

Recently, coupler-based probes are being developed, in which the signal being tested is not probed directly, but a magnetic field around the signal is captured. The electromagnetic coupling may cause less perturbation than the “copy and repeat” method. A known drawback with the coupler-based probes is that the small, coupled signals are first translated into digital signals in order to be used for debug and trace capture of digital systems.

### BRIEF DESCRIPTION OF THE DRAWINGS

The foregoing aspects and many of the attendant advantages of the subject matter described herein will become more readily appreciated as the same becomes better understood by reference to the following detailed description, when taken in conjunction with the accompanying drawings, wherein like reference numerals refer to like parts throughout the various views, unless otherwise specified.

FIG. 1 is a block diagram of a system including an electro-optical debug architecture, according to some embodiments;

FIG. 2 is a block diagram of a system including a second electro-optical debug architecture, according to some embodiments;

FIGS. 3A-3D are oscilloscope readings of the system of FIG. 2, according to some embodiments;

FIG. 4 is an oscilloscope reading of the system of FIG. 1, according to some embodiments;

FIG. 5 is a block diagram of a system including a third electro-optical debug architecture, according to some embodiments;

FIG. 6 is a block diagram of a physical implementation of an electro-optical debug architecture, according to some embodiments;

FIG. 7A is a block diagram of a system for accepting an electro-optical debug architecture, according to some embodiments;

FIG. 7B is a block diagram of the system of FIG. 7A, in which the electro-optical debug architecture is present, according to some embodiments; and

FIG. 8 is a block diagram of a processor-based system using the debug interface of FIG. 1, according to some embodiments.

### DETAILED DESCRIPTION

In accordance with the embodiments described herein, an electro-optical debug architecture and method for performing analysis of electrical signals in a system is disclosed. The system includes at least two circuit elements between which an electrical signal is transmitted. The method converts the electrical signal to dual optical signals, one of which is converted back to an electrical signal for receipt by the intended circuit element. The second optical signal may be used for analysis or other purposes, such as validation and performance modeling of the system. The second optical signal may be transmitted a great distance, relative to electrical signals, from the system. Analysis of signals in the system may take place in a location remote from the system, as desired. Compared to other analysis methods, the loss in converting the electrical signal to an optical signal, then back to an electrical signal is low (and within system specifications). Analysis of signals having speeds exceeding 5 Gb/s is possible.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

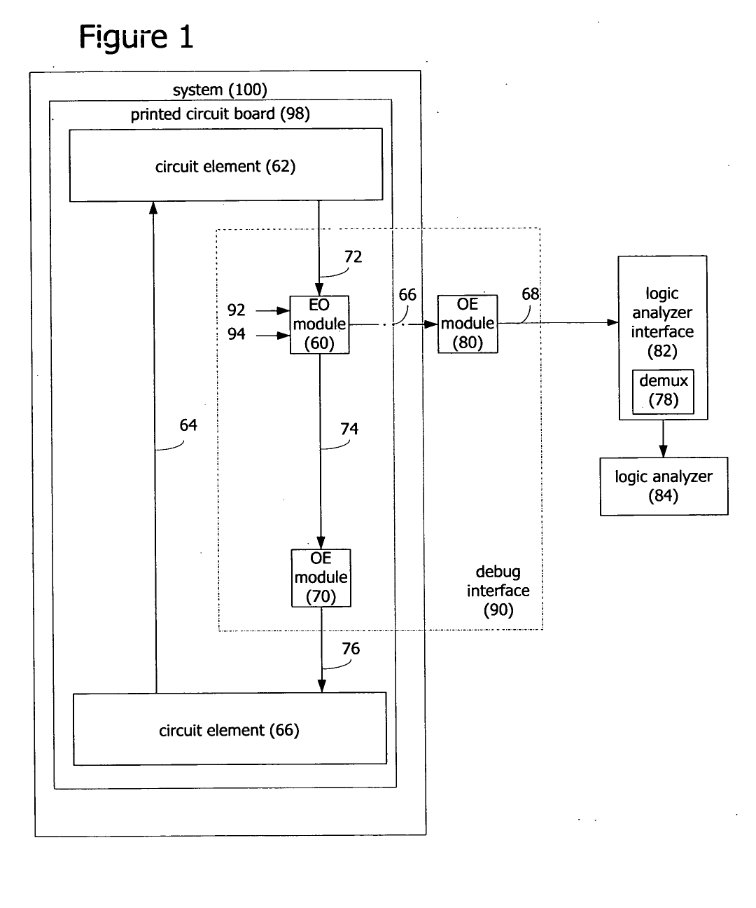

In FIG. 1, a system 100 including an electro-optical debug architecture is depicted, according to some embodiments. Circuit elements 62 and 66 may be processors, chipsets, or other circuits, such as digital signal processors (DSPs), micro controllers, or other logic between which high-speed signals are transmitted. The circuit elements 62 and 66 are disposed on a printed circuit board 98.

The debug interface 90 includes an electro-optical module 60, and opto-electrical modules 70 and 80. In FIG. 1, the debug interface 90 is coupled to a demultiplexer 78, a logic analyzer interface 82, and a logic analyzer 84. The signal 72 to be transmitted from the circuit element 62 to the circuit element 66 is disposed with the debug interface 90. (Similarly, the signal 64 may be disposed with the debug interface 90.)

In serial electro-optical links, the electrical signal may modulate an optical channel. An electrical signal 72 coming from circuit element 62 is received into the electro-optical module 60. Two light sources, such as laser diodes, are driven per electrical signal in the electro-optical module 60, to generate optical signals 92 and 94. The optical signals 92 and 94 may be lasers or other light signals. The incoming electrical signal 72 modulates the two optical signals 92 and 94, producing two optical signals 66 and 74. In some embodiments, the optical signals 66 and 74 are substantially similar to one another. As another option, a single optical signal, such as a laser, may be received into the electro-optical module 60, after which the optical signal (having a first intensity) may be split into two optical signals (each having a second intensity, the second intensity, in some embodiments, being half of the first intensity). Thus, the electrical signal 72 passes through the electro-optical module 60, and modulates the two optical signals, producing two optical signals 66 and 74 that represent the original electrical signal 72.

The optical signal 74 is then received into the opto-electrical module 70 and changed, or converted, into electrical signal 76, to be received by the circuit element 66. The opto-electric module 70 (80) includes a photon converter, such as a p-type-insulator-n-type (PIN) detector, a photo-diode, or similar device, in which incoming photons from the incoming optical signal 74 (66) are excited, releasing electrons. (A PIN detector is a device consisting of p-type material and n-type material, with an insulator material between the two.) The electrons are then collected and transmitted as the electrical signal 76 (68). The second optical signal 66 is then received into the opto-electrical module 80 and converted back to an electrical signal 68. In some embodiments, the electro-optical module 60 is a light-emitting diode (LED) or a modulator.

One benefit to converting the electrical signal 72 into optical signals 74 and 66 is that loss of the optical signal along the optical fiber path is very small, relative to loss along electrical signaling paths, such as traces. Thus, the signals 66 and 74 may travel a great distance with relatively little loss. While the optical signal path for the signal 74 may be small (the path likely remaining on the PCB of the system 100), the optical signal 66, by contrast, may travel on a relatively long optical path (e.g., up to ten meters) with very little loss. The optical path for the signal 74 may be etched into the printed circuit board 98 or may be a fiber optical cable. The ability of the debug interface 90 to have some components reside on the system under test while other components are remote enables the system 100 to be debugged, validated, or performance modeled from a remote location. As logic analyzers tend to be very large, power-consuming equipment relative to the systems they analyze, power and thermal issues associated with such analysis may be avoided by isolating this system 100 from the test equipment.

Although the debug interface 90 is depicted in FIG. 1 as a unitary block, the elements of the debug interface 90 may be physically separated, allowing remote debug of the system 100. The electro-optical module 60 and the opto-electrical module 70 may be disposed on the printed circuit board 98 while the opto-electrical module 80 may be located far from the board 98. In some embodiments, the signal 72 being received from circuit element 62 is substantially similar to the signal 76 being received into the circuit element 66. As with other debug methods, some loss due to latency may occur.

Another concern is the number of transformations of the signal 72 prior to receipt (as signal 76) by circuit element 66. In communication from circuit element 62 to circuit element 66, the electrical signal 72 is transformed into optical signal 74, then back to electrical signal 76.

The electrical signal 68 received from the opto-electrical module 80 may be received into the logic analyzer interface 82. In some embodiments, the logic analyzer interface 82 includes a demultiplexer 78 or other logic to slow down the signal 68 prior to receipt by the logic analyzer 84. Practically, the signal 68 may be transmitted at a much faster data rate than the logic analyzer is capable of interpreting. For example, the signal 68 may run at 10 Gb/s while the logic analyzer 84 operates at less than 1 Gb/s. The demultiplexer 78 is therefore used to slow the signal 68 down prior to receipt by the logic analyzer 84.

In order for the analysis to be representative of the signaling between circuit element 62 and circuit element 66, the signals 76 and 68, both of which are electrical signals, are substantially similar to one another, in some embodiments. However, the signaling path for the optical signal 66 may be significantly longer than the signaling path for the optical signal 74. Because the optical signals experience minimal loss, even on longer signaling paths relative to electrical signaling paths, the signals 68 and 76 were found to be substantially similar, in some embodiments, even for high-speed signals (e.g., 10 Gb/s).

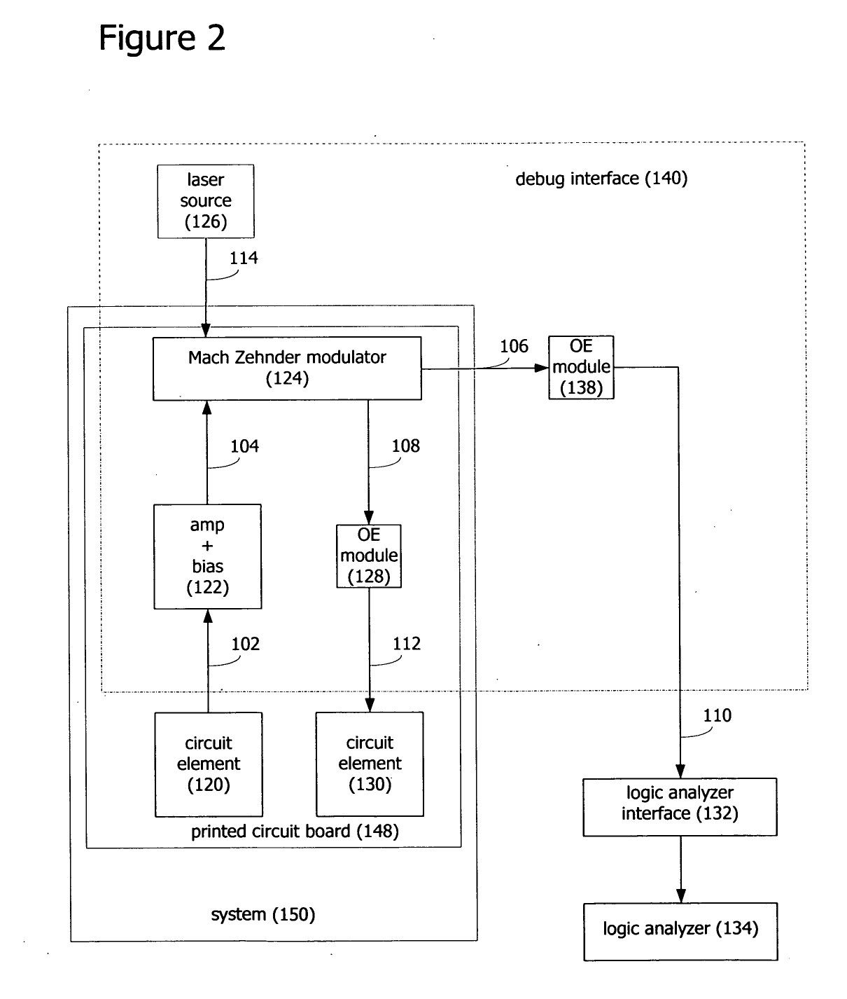

In FIG. 2, a system 150 with an electro-optical debug architecture is depicted, according to some embodiments. The system 150 includes a debug interface 140, for analyzing signals between circuit elements 120 and logic 130. The debug interface 140 includes a Mach Zehnder modulator 124, which converts an electrical signal to an optical signal using a laser source 126, as well as an amplifier/bias circuit 122, and opto-electrical modules 128 and 138. The debug interface 140 is connected to a logic analyzer interface 132 and a logic analyzer 134.

An electrical signal 102 is transmitted by the circuit element 120. When the system 150 is not in debug mode, the intended recipient of the signal 120 is the circuit element 130. During debug mode, the debug interface 140 intercepts the signal 102. The signal passes through an amplifier/bias circuit 122 as signal 104. The amplifier/bias circuit 122 processes the signal 102 to ensure that the signal 104 received by the modulator 124 is of a sufficient strength to modulate the laser signal 114.

The Mach Zehnder modulator 124 receives the signal 104, as well as a laser (optical) signal 114 from the laser source 126. The electrical signal 104 modulates the laser signal 114 in the Mach Zehnder modulator 124, to produce substantially similar optical signals 106 and 108. The laser signal 114 is thus a carrier of the electrical signal 104. The Mach Zehnder modulator 124 is capable of generating two substantially similar optical signals 106 and 108, each containing all the information from the original electrical signal 104.

Within the debug interface 140, the optical signal 108 is transmitted to the opto-electrical module 128, which converts the optical signal 106 into an electrical signal 112, for receipt by the circuit element 130. The optical signal 106 is also converted to an electrical signal 110 by the opto-electrical module 138. The electrical signal 110 is received into a logic analyzer interface 132, then a logic analyzer 134 for analysis. The logic analyzer interface 132 may include circuitry for de-multiplexing the high-speed signal 110, such as when slower test equipment is used.

The debug interface 140 may include circuitry that is physically close to the circuit elements 120 and 130, or the circuitry may be physically remote from the circuit elements. For example, the laser source 126, the Mach Zehnder modulator 124, the amplifier/bias circuit 122, and the opto-electrical module 128 may be part of the printed circuit board 148, upon which the circuit elements 120 and 130 reside, or they may be part of a plug-in board connectable to the printed circuit board. Or, the laser source 126 may be physically remote from the printed circuit board 148. The optical signal 106 may be transmitted across an optical signaling path that may be quite long (e.g., ten meters), such that the opto-electrical module 138, the logic analyzer interface, 132, and the logic analyzer 134 may be located far from the circuit elements 120 and 130.

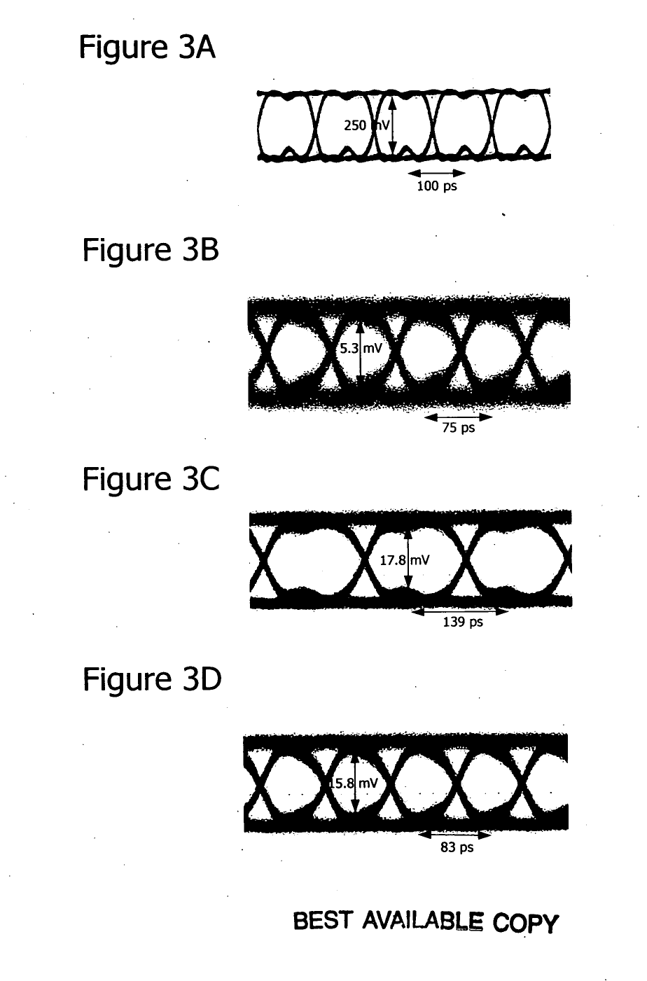

FIGS. 3A and 3B are diagrams of oscilloscope readings of a bit error rate tester coupled to the system 150 of FIG. 2, according to some embodiments. The reading in FIG. 3A is the electrical signal 102 transmitted by the circuit element 120. The time window of the signal is 100 picoseconds (ps) and the amplitude is 250 millivolts (mV). The reading in FIG. 3B is the optical signal 106 produced by the Mach Zehnder modulator 124. The time window is 75 ps and the amplitude is 5.3 mV. To produce the results shown in FIGS. 3A and 3B, the electrical signal 102 was a 10 Gb/s, 250 mV (peak-to-peak) input signal modulating the Mach Zehnder modulator 124 having a Vpi of approximately 6V. A clear (digital looking) eye is observed at the oscilloscope. The sensitivity is good, as even the discontinuity in the input is being observable. Therefore, the electro-optical “copy and repeat” debug technique described herein may be used as a high-bandwidth, low-resolution analog probe. To increase the height of the eyes at the receiver, the inputs may be increased, differential inputs may be used, the light wavelength of the laser may be decreased from 1310 nm to 800 nm or less, or newer modulators may be used.

Additional experiments in converting high-speed electrical signals into optical signals have produced promising results, in some embodiments. A 6.4 Gigabit/second (Gb/s), 500 mV (peak-to-peak) signal modulates a light source, producing an optical signal depicted in FIG. 3C. Again, a clear eye is observed, in which distinct ones and zeroes are observable. The optical signal in FIG. 3C has a time window of 139 ps and an amplitude of 17.8 mV. In FIG. 3D, a 10 Gb/s, 500 mV (peak-to-peak) electrical signal is converted into an optical signal with a time window of 83 ps and an amplitude of 15.8 mV.

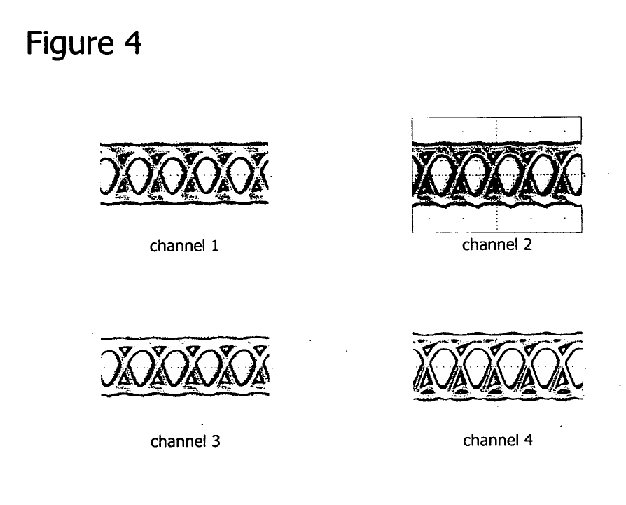

In FIG. 4, four channels of data are depicted, in which the system 100 of FIG. 1 was analyzed using four separate inputs, according to some embodiments. In this experiment, the electro-optical module 60 uses a laser diode as the light source. In converting the electrical signal 72 to an optical signal 74, a latency of one to two picoseconds was observed. Likewise, in converting the optical signal 74 back to an electrical signal 76, a one- to two-picosecond latency was observed. Four sets of signals 72 were transmitted from the circuit element 62, converted to four distinct optical signals 74, and converted back to four different electrical signals 76. Each of the signals 76 is hooked up to a separate oscilloscope, the displays being labeled channel 1, channel 2, channel 3, and channel 4. This experiment demonstrates the viability of using one of the signals 76 for analysis. Further, the method described herein demonstrates a lower latency than the traditional copy and repeat method described above. Also, this experiment demonstrates that analysis of multiple signals, such as bus signals, may be performed simultaneously.

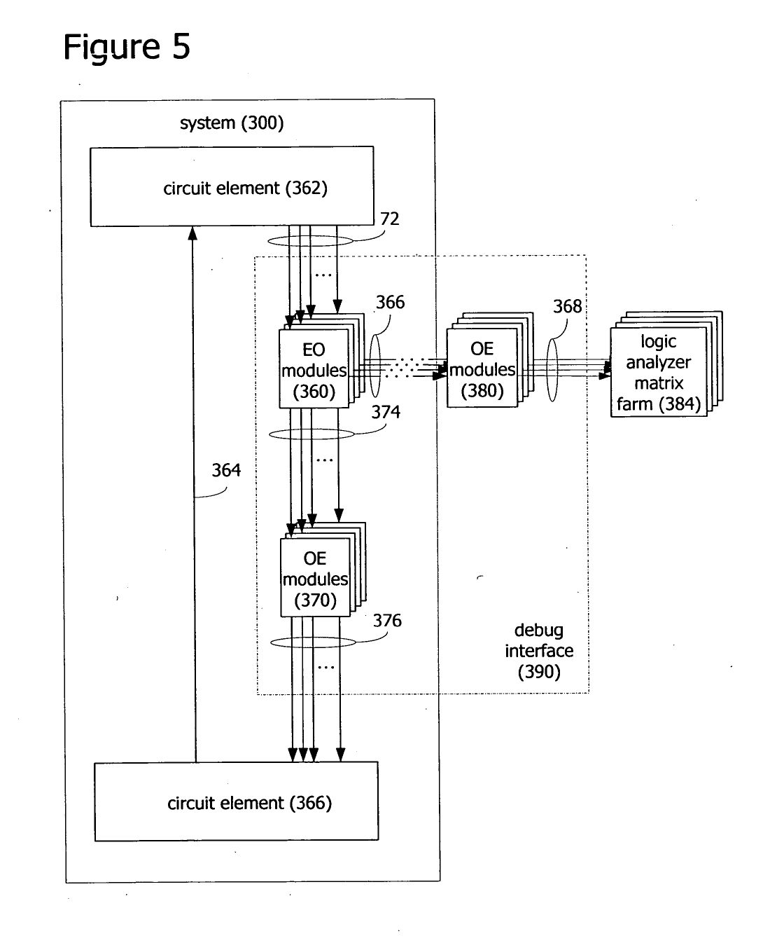

The diagrams of FIGS. 3A-3D and 4 demonstrate that using electro-optical modulation may be viable for current systems. The modulators have a high bandwidth, that is, the modulators are capable of processing very high frequency signals. In some embodiments, the modulators are capable of processing signals with speeds of up to 40 Gb/s. Further, the voltage requirements of the modulators are not excessively high. Thus, low voltage electrical signals are successfully converted to clean optical signals. In FIG. 3A, an electrical signal of 250 mV amplitude was successfully converted to an optical signal (FIG. 3B). Such characteristics may offer reasonable analog probing capability when using an oscilloscope. Add paragraph here In FIG. 5, a system 300 for performing electro-optical debugging is depicted, according to some embodiments. The system 300 may be used to simultaneously analyze multiple signals, such as bus signals. In contrast to the systems 100 (FIG. 1) and 150 (FIG. 2), the debug interface 390 includes a plurality of electro-optical modules 360 to receive the plurality of electrical signals 72 and generate two sets of optical signals 366 and 374, a plurality of opto-electrical modules 370, to convert the plurality of optical signals 374 to a plurality of electrical signals 376. The debug interface 390 also includes a plurality of opto-electrical modules 380 to convert the plurality of optical signals 366 to a plurality of electrical signals 368, to be received into a matrix farm 384 of logic analyzers. As shown, the debug interface 390 is capable of performing simultaneous analysis of many signals. In some embodiments, the logic analyzer matrix farm 384 is remote from the circuit elements 362 and 366. In such a configuration, the thermal, space, and other issues associated with the matrix farm 384 may be addressed in the space housing the matrix farm, away from the rest of the system 300.

There are several advantages to using one of the above electro-optical debug architectures depicted in FIGS. 1, 2, and 5. For one, the optical signals may produce strong optical pulses, resulting in a good bit error rate. This enables interfacing to digital logic, such as complementary metal-oxide semiconductor (CMOS) circuits, possible. Further, the laser source (such as the laser source 126 in FIG. 2) and much of the debug interface may be physically remote from the signal under test (validated, debugged, or analyzed for performance). Thus, the logic analyzer, the logic analyzer interface, and one of the opto-electrical modules may be located far from the system. By conducting tests remotely, the system is less likely to experience test equipment-based perturbation. The physical remoteness also allows sharing of the test equipment between multiple system platforms, which may lower the cost of analysis.

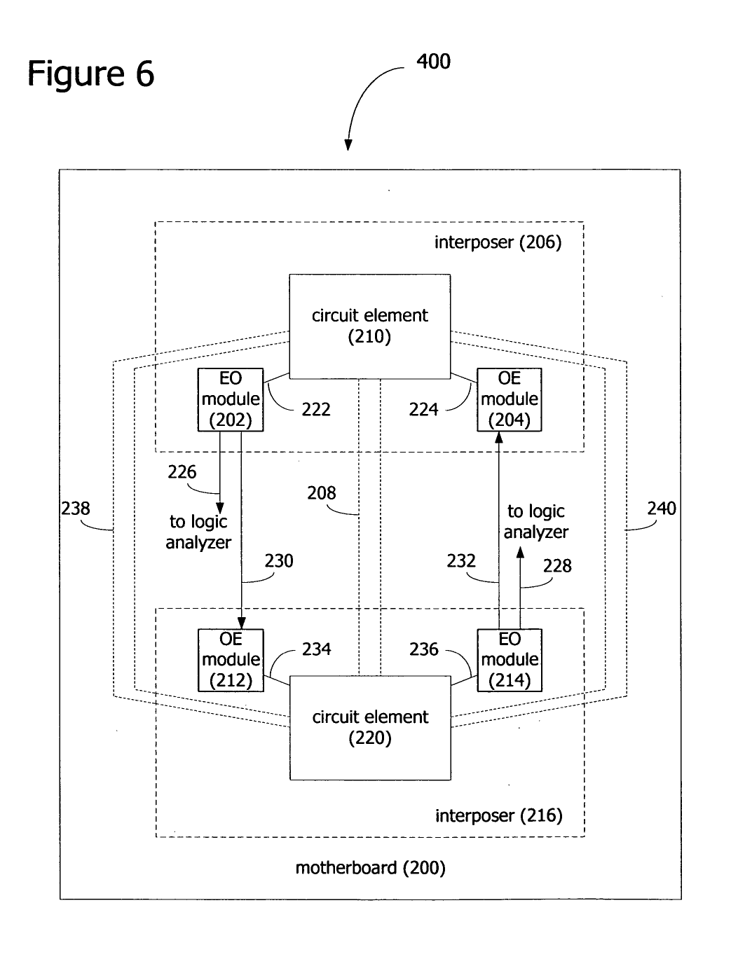

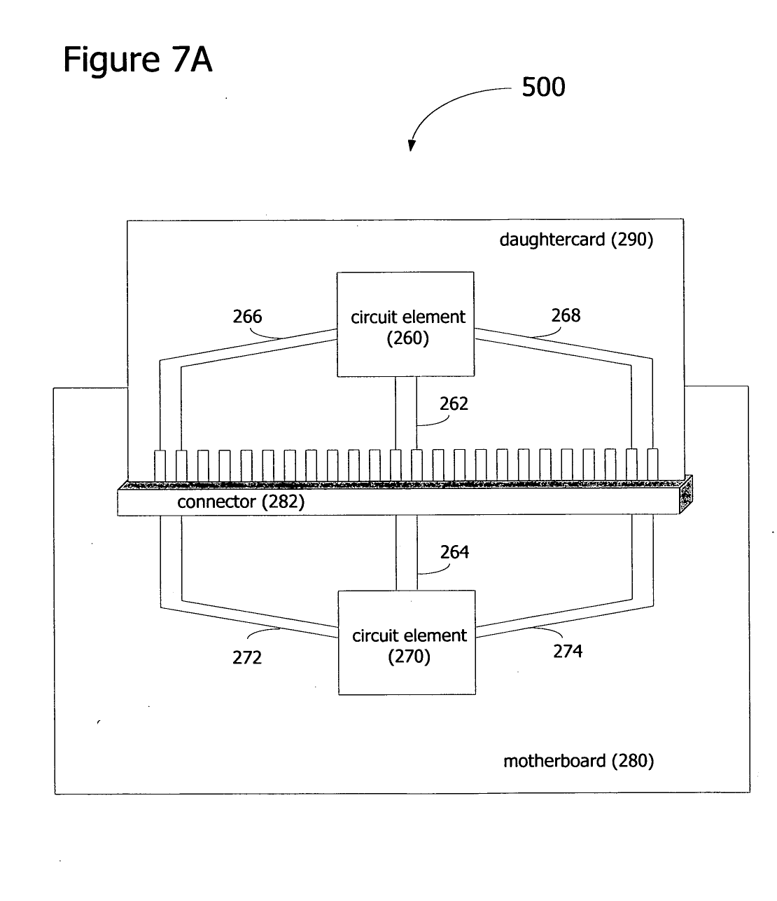

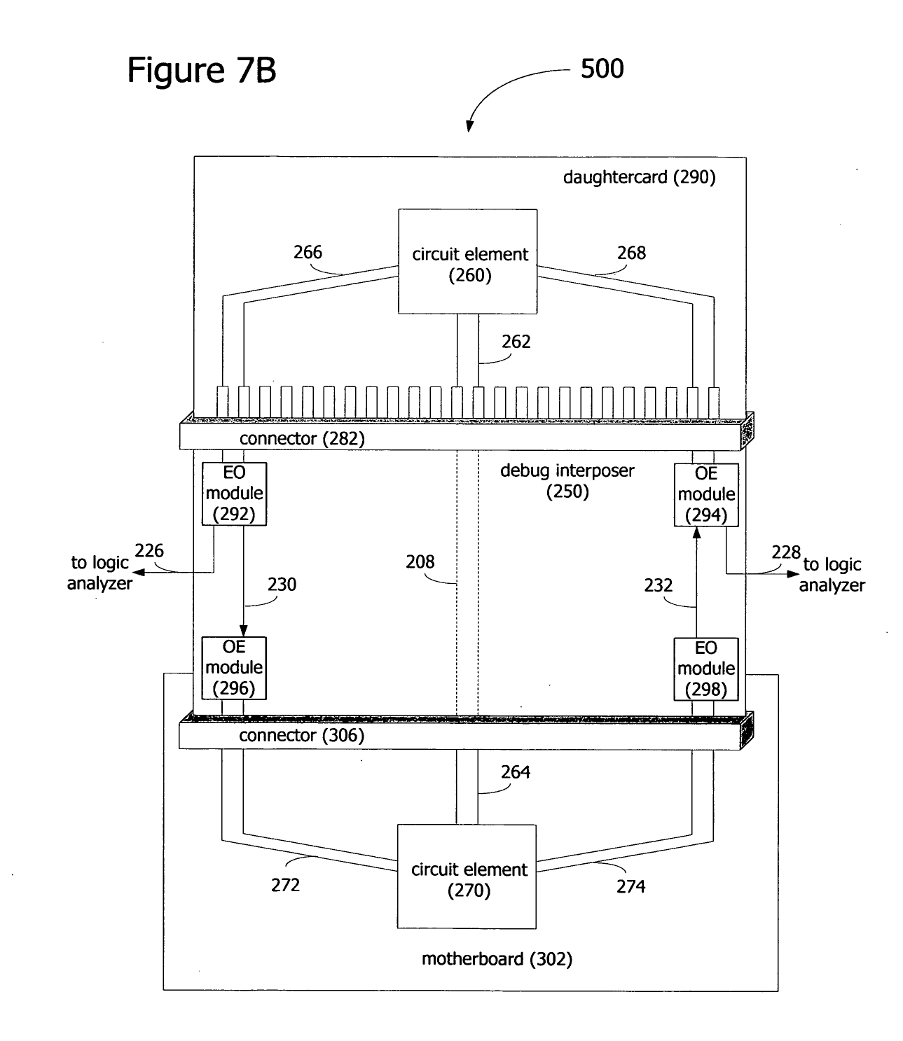

In FIG. 6, a system 400 is depicted, including an electro-optical debug architecture, according to some embodiments. In the system 400, where FIGS. 1, 2, and 5 depict the arrangement of components of the electro-optical debug architecture, FIGS. 6, 7A, and 7B depict possible physical arrangements of the electro-optical debug architecture. Two interposer boards 206 and 216 are disposed upon a motherboard 200. The interposer boards 206 and 216 may be attached to the motherboard by dedicated connectors disposed beneath the circuit element and the motherboard 200, as one example. Thus, the interposer 206 is disposed between the circuit element 210 and the motherboard 200 while the interposer 216 is disposed between the circuit element 220 and the motherboard 200. The interposer 206 includes an electro-optical module 202 and an opto-electrical module 204. The interposer 216 includes an opto-electrical module 212 and an electro-optical module 214. The opto-electrical and electro-optical components are mounted on the interposer for each circuit element, rather than being mounted on the motherboard 200.

Several signal lines are shown between the circuit elements 210 and 220. The signals are depicted as unitary signals, although the principles described herein may apply to differential signals as well. Electrical signals 208, 238, and 240 are disposed between circuit elements 210 and 220. Where the signals traverse an interposer board to the motherboard, the signals are presumed to transmit from the interposer board to an interface, such as a connector (not shown), then to the motherboard. Differential signals 222 are fed into the electro-optical module 202 and converted to substantially similar optical signals 230 and 226. The optical signal 226 is sent to a logic analyzer or other test equipment (not shown) for analysis. The optical signal 230 is transmitted to the opto-electrical module 212, located on the interposer 216, converted into electrical signal 234, and transmitted to the circuit element 220. The electrical signals 208, 238, and 240 are not analyzed. Signals 208, 238, and 240 may be signals that do not need to be analyzed, such as power or low-speed signals.

Likewise, electrical signals 236 are transmitted from circuit element 220 to the electro-optical module 214, where they are converted to substantially similar optical signals 232 and 228. The optical signal 228 is sent to a logic analyzer or other test equipment (not shown) for analysis. The optical signal 232 is transmitted to the opto-electrical module 204 located on the interposer 210, converted into electrical signal 224, and transmitted to the circuit element 210.

In FIGS. 7A and 7B, a system 500 is depicted, according to some embodiments. The system 500 is shown without the opto-electrical debug architecture (FIG. 7A) and with the opto-electrical debug architecture (FIG. 7B). In FIG. 7A, a daughtercard 290 includes circuit element 260 while a motherboard 280 includes circuit element 270. A connector 282 enables the daughtercard 290 to be coupled with the motherboard 280. Electrical signals 266 are transmitted from the circuit element 260, through the connector 282 as electrical signals 272, to be received by circuit element 270. The signals may be unitary or differential signals. Electrical signals 262 are transmitted from the circuit element 260, through the connector 282 as electrical signals 264, to be received by circuit element 270. The electrical signals 268 are transmitted from the circuit element 260, through the connector 282 as electrical signals 274, to be received by circuit element 270. The connector 282 is impedance-matched with the motherboard 280 and the daughtercard 290, such that signals 266 are substantially similar to signals 272, signals 262 are substantially similar to signals 264, and signals 268 are substantially similar to signals 274.

In FIG. 7B, a debug interposer 250 is seated between the motherboard 302 and the daughtercard 290, according to some embodiments. The debug interposer 250 includes the electro-optical debug architecture described above, including two electro-optical modules 292 and 298 and two opto-electrical modules 294 and 296. Electrical signals 262, 266, and 268 are transmitted from circuit element 260 to the debug interposer 250. The signals 262 are not converted to optical signals, but pass through the connector 282 as electrical signals 208, then pass through connector 306 as electrical signals 264, to be received by circuit element 270.

The electrical signals 266 and 268, however, are converted to optical signals for analysis. The electrical signals 266 pass through the connector 282, to be received into the electro-optical module 292, and are then converted into substantially similar optical signals 226 and 230. The optical signals 226 are transmitted to a logic analyzer (not shown), which may be physically remote from the system 500. In some embodiments, the logic analyzer is ten meters away from the system 500, with minimal loss of signal integrity. The optical signals 230, still on the debug interposer board 250, are then transmitted to the opto-electrical module 296, where they are converted to electrical signals 272, to be received by the circuit element 270 located on the motherboard 302. Similarly, the electrical signal 268 is converted to optical signals 228 and 232, the first of which is transmitted to a logic analyzer (not shown), the other of which is converted back to an electrical signal 274, for receipt by circuit element 270.

The electro-optical debug architecture described herein may permit system validation and performance modeling, even for high-speed systems. In some embodiments, minimal system perturbation (latency, power delivery, and cooling) was found using the electro-optical debug architecture. The electro-optical debug architecture further permits the allocation of debug resources in a location that is physically remote from the system under test. This facilitates resource sharing, such as in a manufacturing environment in which hundreds of systems are being tested, for a cost savings. Essentially, a “free” copy of the signal, in optical form, is made in the electro-optical modulator, which may be exploited in the test environment.

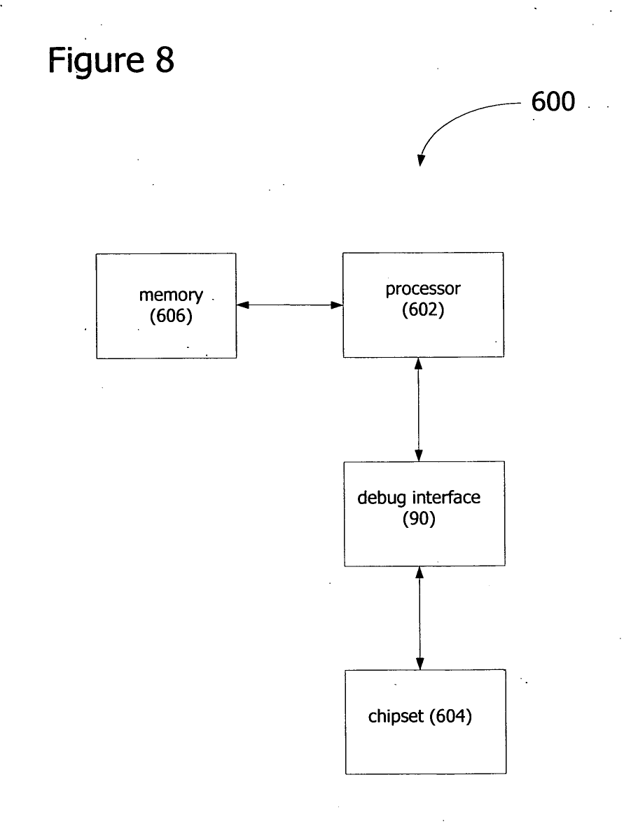

In FIG. 8, a processor-based system 600 employs the debug interface 90 of FIG. 1, according to some embodiments. The processor-based system 600 includes a processor 602, to execute instructions, a chipset 604, and a memory 606. The chipset 604 may connect to a number of peripheral devices, such as drive media, keyboard, and mouse (not shown), and may include circuitry to facilitate the function of the connected devices. The memory 606 is coupled directly to the processor 602, for fast execution. The debug interface 90 intercepts electrical signals being transmitted between the processor 602 and the chipset 604, as described above.

While the subject matter has been described with respect to a limited number of embodiments, those skilled in the art will appreciate numerous modifications and variations therefrom. It is intended that the appended claims cover all such modifications and variations as fall within the true spirit and scope of the subject matter.

We claim:

1. An apparatus, comprising:
a first module to receive an electrical signal from a first circuit element, the first module to generate a first optical signal and a second optical signal;
a second module to receive the first optical signal, the second module to generate a second electrical signal; and
a third module to receive the second optical signal, the third module to generate a third electrical signal, the third electrical signal to be transmitted to a second circuit element.

2. The apparatus of claim 1, the first module to receive a third optical signal from a light source, the electrical signal to modulate the third optical signal to generate the first optical signal and the second optical signal.

3. The apparatus of claim 1, the first module to receive a third optical signal from a a first light source and a fourth optical signal from a second light source, wherein the electrical signal modulates the third optical signal to generate the first optical signal and the electrical signal modulates the fourth optical signal to generate the second optical signal.

4. The apparatus of claim 2, wherein the light source is a laser diode.

5. The apparatus of claim 2, wherein the first module is a Mach Zehnder modulator.

6. The apparatus of claim 1, the first circuit element and the second circuit element being disposed on a printed circuit board, wherein the second module is not disposed on the printed circuit board.

7. The apparatus of claim 1, wherein the second module is remote from the first circuit element and the second circuit element.

8. The apparatus of claim 6, further comprising:
test equipment to receive the second electrical signal.

9. The apparatus of claim 6, the first optical signal to travel along a first optical path, wherein the first optical path is not disposed on the printed circuit board.

10. The apparatus of claim 6, the second optical signal to travel along a second optical path, wherein the second optical path is disposed on the printed circuit board.

11. The apparatus of claim 10, the second optical signal to travel along a second optical path, wherein the second optical path is shorter than the first optical path.

12. The apparatus of claim 8, further comprising:
a demultiplexer disposed between the second module and the test equipment, the demultiplexer to receive the second electrical signal at a first speed, the demultiplexer to transmit the second electrical signal to the test equipment at a second speed, wherein the second speed is slower than the first speed.

13. The debug interface of claim 1, wherein the second module is physically remote from the first circuit element and the second circuit element.

14. A method, comprising:
receiving an electrical signal from a circuit element;
modulating a light signal from a light source using the electrical signal to produce a first optical signal and a second optical signal—put in dependent claim;
transmitting the first optical signal over a first optical signaling path;
converting the first optical signal to a second electrical signal.

15. The method of claim 14, wherein modulating a light signal from a light source comprises:
modulating a first light signal using the electrical signal to produce the first optical signal; and
modulating a second light signal using the electrical signal to produce the second optical signal.

16. The method of claim 14, wherein modulating a light signal from a light source comprises:
modulating the light signal using the electrical signal to produce an original optical signal, the original optical signal having an intensity; and
splitting the original optical signal into the first optical signal and the second optical signal

17. The method of claim 14, wherein converting the first optical signal to a second electrical signal comprises:
exciting photons in the first optical signal, such that electrons are released; and
collecting the released electrons as the second electrical signal.

18. A system, comprising:
a processor to execute instructions;
a memory coupled to the processor; and
an apparatus coupled between the processor and a chipset, the apparatus comprising:
a first module to receive an electrical signal from the processor, the first module to generate a first optical signal and a second optical signal;
a second module to receive the first optical signal, the second module to generate a second electrical signal; and
a third module to receive the second optical signal, the third module to generate a third electrical signal, the third electrical signal to be transmitted to the chipset.

19. The system of claim 18, the processor and the chipset being disposed on a printed circuit board, wherein the second module is not disposed on the printed circuit board.

20. The system of claim 19, wherein the first module is a Mach Zehnder modulator.
